(19) United States
(12) Patent Application Publication
(10) Pub. No.: US 2008/0303819 A1
(43) Pub. Date: Dec. 11, 2008

(54) Method and apparatus for comparing program graphs

(76) Inventors: Pierre-Olivier Latour, Menlo Park, CA (US); Alessandro Sabatelli, San Francisco, CA (US); Troy Koelling, Santa Clara, CA (US); Nathan Wertman, Boulder Creek, CA (US)

Correspondence Address: PVF -- APPLE INC.;c/o PARK, VAUGHAN & FLEMING LLP, 2820 FIFTH STREET, DAVIS, CA, 95618-7759, US

(21) Appl. No.: 11/811,119

(22) Filed: Jun. 8, 2007

(51) Int. Cl. G06T 11/20

(52) U.S. Cl. 345/440

(57) ABSTRACT

One embodiment of the present invention provides a system that highlights differences between two graphs that represent programs in a graphical programming language. During operation, the system identifies unique nodes in the two graphs which are not identical to any other node in the other graph. Note that each of the two graphs comprises a set of interconnected nodes which represent functions in the graphical programming language. The system then displays the two graphs within the same editor window, and while doing so highlights nodes which do not have identical counterparts in the other graph.

### BACKGROUND

1. Field of the Invention

The present invention relates to the design of user interface for a graphical programming language. More specifically, the present invention relates to a method and an apparatus that facilitates visually comparing the difference between two program graphs in a graphical programming language interface.

2. Related Art

A graphical programming language (GPL) enables a programmer to interact with programs by graphically manipulating program components through a graphical user interface (GUI). Specifically, a program within a GPL is typically comprised of multiple base processing units, such as subroutines, or functions, and these base processing units are represented graphically as “boxes” or “patches” within the GUI. Each “patch” can have a number of input ports for receiving input variables/parameters, and a number of output ports for outputting results when the patch is executed. The relationships between patches can be understood by viewing their spatial arrangements and associated connectivity information within the GUI. This connectivity information is typically illustrated using lines, arrows, or arcs that connect the output ports of upstream patches to the input ports of downstream patches. The collection of the patches and the connections between the patches form a “graph” structure for a corresponding program.

Note that when editing text-based documents, changes from one version to another can be easily detected, for example, by using a text-document-comparison tool. However, in graph-based programming, it is significantly more difficult to quickly identify the structural differences between two versions of the same program graph. This problem is inherent to the fact that program graphs are two-dimensional (2D) objects, and therefore the layout of a program graph is not necessarily correlated with the structure of the graph. For example, a programmer can move a patch in a graph to a very different location in the editor window without changing any connections to the patch. As a result, the graph structure does not change even though the visual representation has changed.

The above problem becomes even more prominent when the programmer works on a complex graph structure comprising a large number of patches and associated interconnections. For example, when working in collaboration mode on a large program, a program graph may have been modified by another programmer since the last time a primary programmer edited the graph. The primary programmer would ideally like to be able to identify all the changes made to the graph. Unfortunately, by observing two versions of the graph next to each other, it can be extremely hard to distinguish all the differences between the graphs.

Hence, what is needed is a method and an apparatus that facilitates visualizing differences between two 2D program graphs without the above problems.

### SUMMARY

One embodiment of the present invention provides a system that highlights differences between two graphs that represent programs in a graphical programming language. During operation, the system identifies unique nodes in the two graphs which are not identical to any other node in the other graph. Note that each of the two graphs comprises a set of interconnected nodes which represent functions in the graphical programming language. The system then displays the two graphs within the same editor window, and while doing so highlights nodes which do not have identical counterparts in the other graph.

In a variation on this embodiment, the system identifies the unique nodes by: identifying a first node in the first graph and a second node in the second graph which have the same identifier; determining that the first and second nodes are different if: (1) the first and second nodes have at least one connection which is different; or (2) the first and second nodes have at least one internal parameter setting which is different; and if the first node second nodes are different, determining the first node and the second node are unique nodes.

In a further variation, the system identifies the unique nodes by: determining if a node in the first graph has an identifier which does not match an identifier for a node in the second graph or if a node in the second graph has an identifier which does not match an identifier for a node in the first graph; and if so, determining that the non-matching node is a unique node.

In a variation on this embodiment, the system highlights the unique nodes by displaying the unique nodes in a color that indicates that the nodes are unique.

In a variation on this embodiment, the two graphs represent two versions of the same program.

In a further variation on this embodiment, the two graphs represent programs that perform image-conversion operations on images.

In a further variation, the system displays the execution results of the two graphs simultaneously to facilitate a side-by-side comparison.

In a further variation, the system displays the execution results of the two graphs in an overlaid manner to facilitate an overlay comparison.

### BRIEF DESCRIPTION OF THE FIGURES

FIG. 1 illustrates a computer system in accordance with an embodiment of the present invention.

FIG. 2 illustrates an exemplary graph which is comprised of four interconnected nodes in accordance with an embodiment of the present invention.

FIG. 3A illustrates a standard editor window for editing a graph in accordance with an embodiment of the present invention.

FIG. 3B illustrates another standard editor window for editing a graph in accordance with an embodiment of the present invention.

FIG. 3C illustrates how the two graphs can be displayed simultaneously in the same editor window in accordance with an embodiment of the present invention.

FIG. 3D illustrates how both graphs, and the resultant images associated with the graphs can be displayed in the same editor window in accordance with an embodiment of the present invention.

FIG. 4 illustrates an exemplary editor window which facilitates simultaneous comparisons between both graph structures and the corresponding resultant image renderings associated with the two graphs in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Computer System

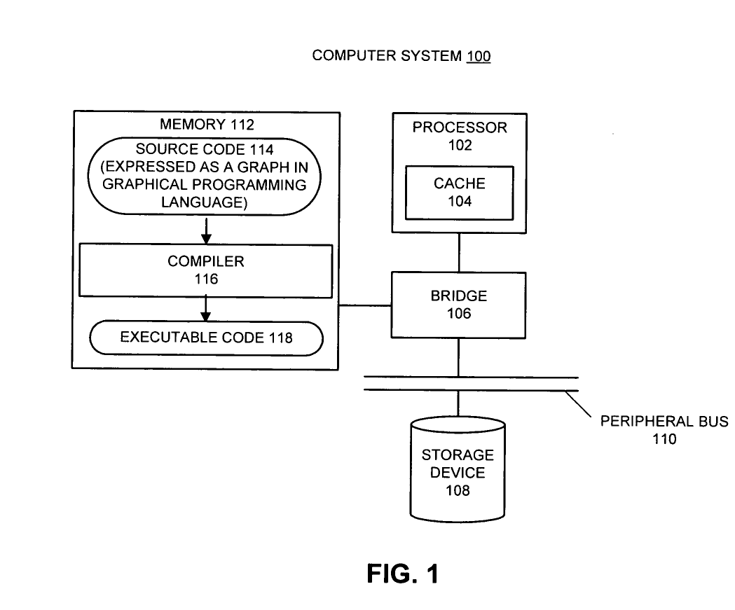

FIG. 1 illustrates a computer system 100 in accordance with an embodiment of the present invention. As illustrated in FIG. 1, computer system 100 includes processor 102, which is coupled to a memory 112 and to peripheral bus 110 through bridge 106. Bridge 106 can generally include any type of circuitry for coupling components of computer system 100 together.

Processor 102 can include any type of processor, including, but not limited to, a microprocessor, a mainframe computer, a digital signal processor, a personal organizer, a device controller and a computational engine within an appliance. Processor 102 includes a cache 104 that stores code and data for execution by processor 102.

Processor 102 communicates with storage device 108 through bridge 106 and peripheral bus 110. Storage device 108 can include any type of non-volatile storage device that can be coupled to a computer system. This includes, but is not limited to, magnetic, optical, and magneto-optical storage devices, as well as storage devices based on flash memory and/or battery-backed up memory.

Processor 102 communicates with memory 112 through bridge 106. Memory 112 can include any type of memory that can store code and data for execution by processor 102.

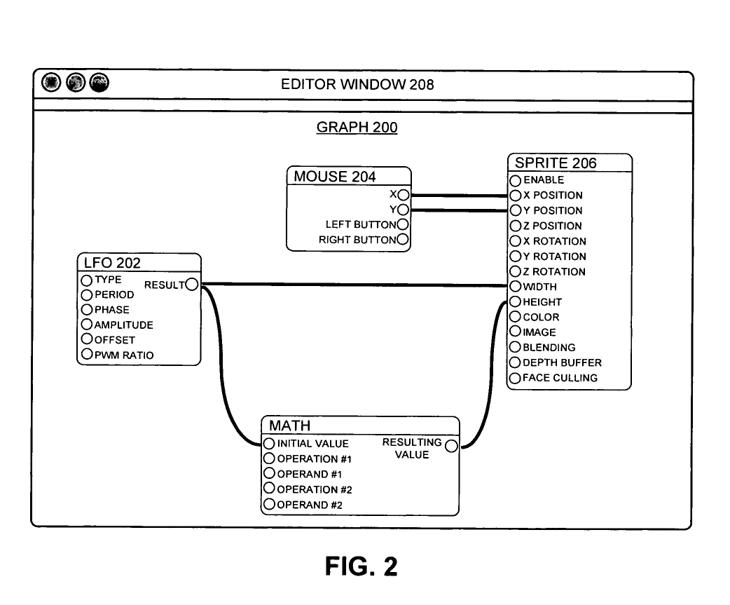

As illustrated in FIG. 1, memory 112 contains compiler 116. Compiler 116 converts source code 114 into executable code 118. In one embodiment of the present invention, source code 114 is developed through a graphical programming language (GPL) and displayed as a program graph within a graphical user interface (GUI). This graphical form of source code 114 is described in more detail below with reference to FIGS. 2-4.

Note that although the present invention is described in the context of computer system 100 as illustrated in FIG. 1, the present invention can generally operate on any type of computing device. Hence, the present invention is not limited to the specific implementation of computer system 100 as illustrated in FIG. 1.

### Node-Based Graphical Programming Language

In a node-based GPL, a “node” refers to a base processing unit in a GPL, such as a subroutine or a function. A set of interconnected nodes in a GPL forms a “program graph” (or simply a “graph”) that represents a program. During a graphical programming operation, a programmer typically creates a graph by dragging nodes associated with different functions into a workspace and making connections between the nodes. Note that generally both nodes and graphs are executable programs.

FIG. 2 illustrates an exemplary graph 200 which is comprised of four interconnected nodes in accordance with an embodiment of the present invention. Note that each node in graph 200 can have one or more input ports and one or more output ports, which are illustrated as circles. Each port (either an input port or an output port) is associated with a variable or a parameter. Note that while some nodes can have both input and output ports, other nodes can have only input ports or only output ports. For example, “Low Frequency Oscillator” (LFO) node 202 has both input and output ports, wherein the input ports—Type, Period, Phase, Amplitude, Offset, and PWM Ratio, provide parameters which are used to compute the amplitude of an oscillation at a specific time. The computed amplitude value is then available on the output port of the LFO node. A “Mouse” node 204, which represents functions of a computer mouse, has no input ports, and four output ports that specify mouse location and button states. Note that both the LFO and Mouse nodes produce output that can be used as input to another node. A “Sprite” node 206 has multiple input ports, but no output port. Instead, the Sprite node renders its result to a destination.

Note that the value on an input port of a node can be set directly by connecting the output of an upstream node to the input port. Connections between input and output ports of different nodes establish a data flow in the graph structure. Note that a connection is made between ports that have compatible data types. Hence, if two ports are of different types, a type conversion operation is needed between the two ports before they can be connected.

Note that the value of an input/output port of a node in the specification is broadly defined to include different types of data objects, which can include, but are not limited to a number, a string or a bitmap. In one embodiment of the present invention, an input port value is an image.

Note that if a node in graph 200 is moved around within the two-dimensional (2D) space of editor window 208 without changing any of the connections associated with the node, both the structure and the function of graph 200 do not change.

Displaying Two Program Graphs within the Same Editor Window

Embodiments of the present invention facilitate displaying two program graphs within the same editor window for comparison purposes. In one embodiment of the present invention, the two graphs represent two versions of the same program. By displaying the two versions of the program side by side within the same editor window, it becomes easier to distinguish the differences between the two graphs.

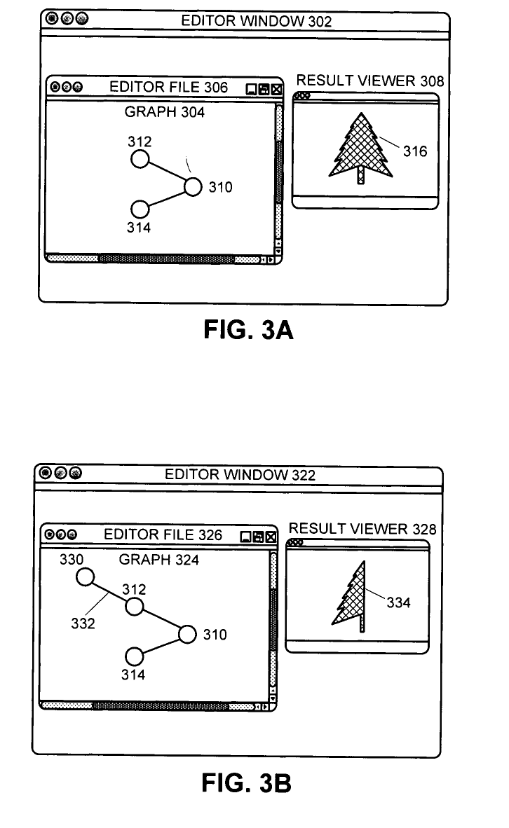

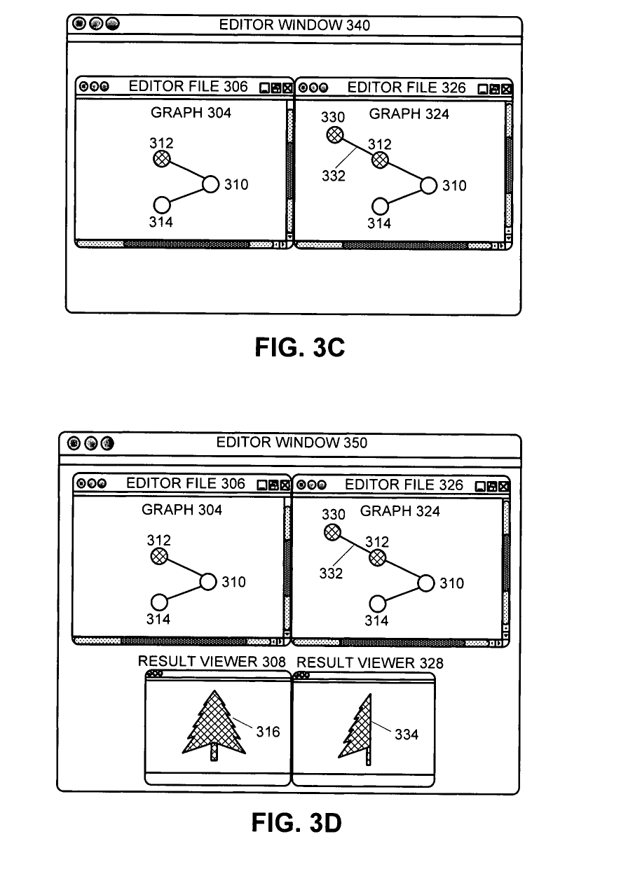

FIGS. 3A-3C illustrate how a user can view a modified graph in an editor window in accordance with an embodiment of the present invention.

Specifically, FIG. 3A illustrates a standard editor window 302 for editing a graph 304 in accordance with an embodiment of the present invention. As illustrated in FIG. 3A, editor window 302 comprises an editor file window 306 and a result viewer 308. More specifically, editor file window 306 contains graph 304, which is comprised of three interconnected nodes 310, 312, and 314. Note that nodes 310-314 in graph 304 are illustrated as circles for simplicity purpose, and each line that connects a pair of circles (nodes) represent all the connections between the pair of nodes. In one embodiment of the present invention, executing graph 304 renders an image 316 (i.e., a tree) in result viewer 308.

FIG. 3B illustrates another standard editor window 322 for editing a graph 324 in accordance with an embodiment of the present invention. As illustrated in FIG. 3B, editor window 322 comprises an editor file window 326 and a result viewer 328. More specifically, editor file window 326 contains graph 324, which is comprised of four interconnected nodes 310, 312, 314, and 330 (illustrated as four circles). Note that graph 324 is a modified version of graph 304. Specifically, graph 324 is obtained by adding a new node 330 and new connection 332 to graph 304. Note that when executed, graph 324 renders a corresponding image 334 (i.e., a half tree) in result viewer 328. The differences between the corresponding rendered images of graphs 304 and 324 are caused by the modifications to graph 304.

FIG. 3C illustrates how graphs 304 and 324 can be displayed simultaneously in the same editor window 340 in accordance with an embodiment of the present invention. As illustrated in FIG. 3C, editor file window 306 and editor file window 326 are displayed side by side within editor window 340. Furthermore, both the new node 330 in graph 324 and node 312 in both graphs 304 and 324 are highlighted (with shading) to facilitate visualizing the differences between the two graphs. Note that node 312 is highlighted to reflect a change of connectivity to node 312. Note that it is now easy to compare the structures of the two graphs.

Note that displaying two graphs in the same editor window enables the user to interact with both graphs for comparison purposes. For example, the user can remove node 214 in both graphs and can then compare the effects on the outputs.

FIG. 3D illustrates how both graphs 304 and 324, and the resultant images associated with the graphs can be displayed in the same editor window 350 in accordance with an embodiment of the present invention. Note that in addition to the ability to compare the structures of the graphs side by side, this embodiment also facilitates comparing and visualizing the difference in the results of evaluating the two graphs. Note that a programmer can interact with both graphs that are being compared. Specifically, when a change is made to one the graphs, the programmer can instantly see the effect of the change in the execution result and can compare to the execution result of the unchanged graph.

Identifying and Highlighting Differences between the Two Graphs

As mentioned previously, two graphs having different (2D) layouts may not be structurally different. Hence, when comparing two graphs having complex structures, it is desirable to highlight all the differences between the two graphs.

In one embodiment of the present invention, the system identifies “unique nodes” in each of the two graphs that are being compared in the same editor window. A unique node refers to a node in one graph that is not identical to any other node in the other graph. Specifically, the system identifies a first node in the first graph and a second node in the second graph which have the same identifier. In one embodiment, this identifier is a unique key assigned to the node when the node is first created. If the first and second nodes have the same identifier, the system next determines if the two nodes are different by determining if: (1) the first and second nodes have at least one connection which is different; or (2) the first and second nodes have at least one internal parameter setting which is different.

Note that during step (1) the connectivity difference is examined from both the input port side and the output port side of a node. For example, in FIG. 3D, node 312 in graph 304 and node 312 in graph 324 have the same identifier but different connectivity (node 312 in graph 324 has a new connection 332). Hence, node 312 in graph 304 and node 312 in graph 324 are different. Note that a node can also be modified by changing one or more internal parameter settings. This difference is examined during step (2).

If either step (1) or step (2) is determined to be true, the system determines that the first node and second nodes are different, and subsequently identifies both nodes as unique nodes.

In a further embodiment of the present invention, the system identifies unique nodes in each of the two graphs by determining if a node in the first graph has an identifier (e.g., a key) which does not match an identifier for a node in the second graph or vice versa. If so, the system determines that the node is a unique node.

Note that the process of identifying unique nodes in each of the two graphs being compared is not limited to the techniques described above. Any other technique that can identify nodes in one graph that do not have identical counterparts in the other graph is applicable herein.

In one embodiment of the present invention, the identified unique nodes in the two compared graphs are highlighted with the corresponding graph. This facilitates visualizing all the differences between the two graphs. In one embodiment, the system highlights the unique nodes by displaying these unique nodes in a color that indicates they are different from other node.

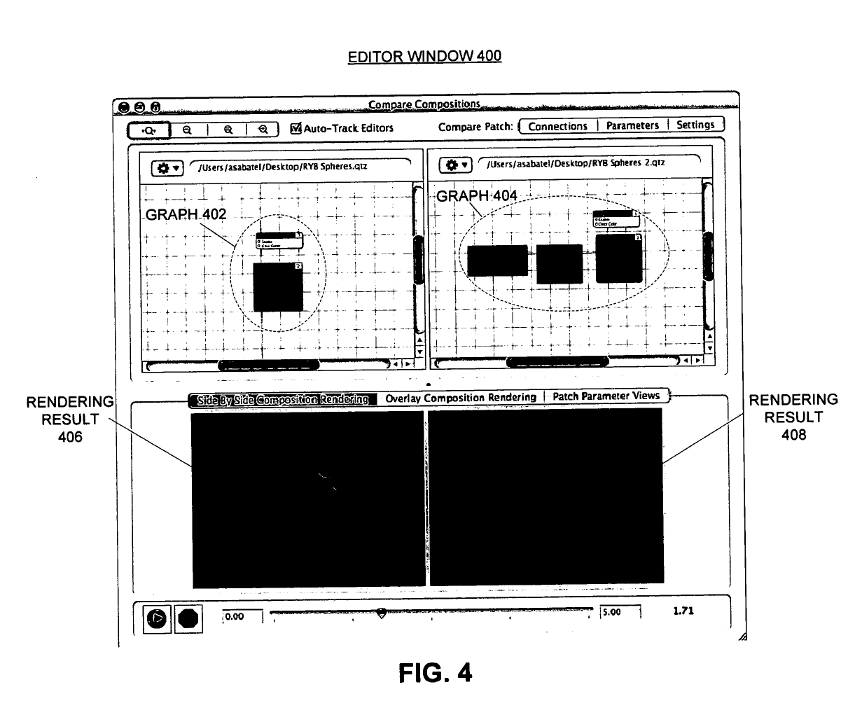

FIG. 4 illustrates an exemplary editor window 400 which facilitates simultaneous comparisons between both graph structures 402 and 404, and the corresponding resultant image renderings 406 and 408 associated with the two graphs in accordance with an embodiment of the present invention. Note that identified unique nodes in graphs 402 and 404 are highlighted with pink body color, whereas identical nodes are represented in plain white body color. Also note that graphs 402 and 404 represent two versions of a program that performs image-conversion operations on a certain input image.

Note that in addition to displaying the rendering results of the two graphs simultaneously to facilitate a side-by-side comparison, embodiments of the present invention also provide an option to display the rendering results of the two graphs in an overlaid manner to facilitate an overlay comparison. This option is illustrated in FIG. 4 as the center tab ”Overlay Composition Rendering” which is situated above the rendered images. When this option is selected, the system can create a single output image that is the composition of two images 406 and 408. The system can then apply existing image processing tools on the composite image. For example, the system can provide a knob that when adjusted, varies the transparency of the top image so that the bottom image becomes more visible or less visible.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for highlighting differences between two graphs that represent programs in a graphical programming language, comprising:
identifying unique nodes in the two graphs which are not identical to any other node in the other graph;
wherein each of the two graphs comprises a set of interconnected nodes which represent functions in the graphical programming language; and
displaying the two graphs within the same editor window, and while doing so highlighting nodes which do not have identical counterparts in the other graph.

2. The method of claim 1, wherein identifying the unique nodes involves:
identifying a first node in the first graph and a second node in the second graph which have the same identifier;
determining that the first and second nodes are different if:
the first and second nodes have at least one connection which is different; or
the first and second nodes have at least one internal parameter setting which is different; and
if the first node second nodes are different, determining the first node and the second node are unique nodes.

3. The method of claim 2, wherein identifying unique nodes involves:
determining if a node in the first graph has an identifier which does not match an identifier for a node in the second graph or if a node in the second graph has an identifier which does not match an identifier for a node in the first graph; and
if so, determining that the non-matching node is a unique node.

4. The method of claim 1, wherein highlighting the unique nodes involves displaying the unique nodes in a color that indicates that the nodes are unique.

5. The method of claim 1, wherein the two graphs represent two versions of the same program.

6. The method of claim 5, wherein the two graphs represent programs that perform image-conversion operations on images.

7. The method of claim 6, wherein the method further comprises displaying the execution results of the two graphs simultaneously to facilitate a side-by-side comparison.

8. The method of claim 6, wherein the method further comprises displaying the execution results of the two graphs in an overlaid manner to facilitate an overlay comparison.

9. A computer-readable storage medium storing instructions that when executed by a computer cause the computer to perform a method for highlighting differences between two graphs that represent programs in a graphical programming language, comprising:
identifying unique nodes in the two graphs which are not identical to any other node in the other graph;
wherein each of the two graphs comprises a set of interconnected nodes which represent functions in the graphical programming language; and
displaying the two graphs within the same editor window, and while doing so highlighting nodes which do not have identical counterparts in the other graph.

10. The computer-readable storage medium of claim 9, wherein identifying the unique nodes involves:
identifying a first node in the first graph and a second node in the second graph which have the same identifier;
determining that the first and second nodes are different if:
the first and second nodes have at least one connection which is different; or
the first and second nodes have at least one internal parameter setting which is different; and
if the first node second nodes are different, determining the first node and the second node are unique nodes.

11. The computer-readable storage medium of claim 10, wherein identifying unique nodes involves:
determining if a node in the first graph has an identifier which does not match an identifier for a node in the second graph or if a node in the second graph has an identifier which does not match an identifier for a node in the first graph; and
if so, determining that the non-matching node is a unique node.

12. The computer-readable storage medium of claim 9, wherein highlighting the unique nodes involves displaying the unique nodes in a color that indicates that the nodes are unique.

13. The computer-readable storage medium of claim 9, wherein the two graphs represent two versions of the same program.

14. The computer-readable storage medium of claim 13, wherein the two graphs represent programs that perform image-conversion operations on images.

15. The computer-readable storage medium of claim 14, wherein the method further comprises displaying the execution results of the two graphs simultaneously to facilitate a side-by-side comparison.

16. The computer-readable storage medium of claim 14, wherein the method further comprises displaying the execution results of the two graphs in an overlaid manner to facilitate an overlay comparison.

17. An apparatus that highlights differences between two graphs that represent programs in a graphical programming language, comprising:
an identification mechanism configured to identify unique nodes in the two graphs which are not identical to any other node in the other graph;
wherein each of the two graphs comprises a set of interconnected nodes which represent functions in the graphical programming language; and
a display mechanism configured to display the two graphs within the same editor window, and while doing so, the display mechanism is configured to highlight nodes which do not have identical counterparts in the other graph.

18. The apparatus of claim 17, wherein the identification mechanism is configured to identify the unique nodes by:
identifying a first node in the first graph and a second node in the second graph which have the same identifier;
determining that the first and second nodes are different if:
the first and second nodes have at least one connection which is different; or
the first and second nodes have at least one internal parameter setting which is different; and
if the first node second nodes are different, determining that the non-matching node is a unique node.

19. The apparatus of claim 18, wherein the identification mechanism is further configured to identify unique nodes by:
determining if a node in the first graph has an identifier which does not match an identifier for a node in the second graph or if a node in the second graph has an identifier which does not match an identifier for a node in the first graph; and
if so, determining the node is a unique node.

20. The apparatus of claim 17, wherein the display mechanism is configured to highlight the unique nodes by displaying the unique nodes in a color that indicates that the nodes are unique.

21. The apparatus of claim 17, wherein the two graphs represent two versions of the same program.

22. The apparatus of claim 21, wherein the two graphs represent programs that perform image-conversion operations on images.

23. The apparatus of claim 22, wherein the display mechanism is further configured to display the execution results of the two graphs simultaneously to facilitate a side-by-side comparison.

24. The apparatus of claim 22, wherein the display mechanism is further configured to display the execution results of the two graphs in an overlaid manner to facilitate an overlay comparison.
